(19) United States
(12) Patent Application Publication
(10) Pub. No.: US 2020/0073183 A1
(43) Pub. Date: Mar. 5, 2020

(54) DISPLAY PANEL AND DISPLAY DEVICE

(71) Applicants: Chongqing HKC Optoelectronics Technology Co., Ltd., Chongqing (CN); HKC Corporation Limited, Shenzhen, (CN)

(72) Inventor: Chunhui Yang, Chongqing (CN)

(21) Appl. No.: 16/241,968

(22) Filed: Jan. 7, 2019

Related U.S. Application Data
(63) Continuation of application No. PCT/CN2018/111335, filed on Oct. 23, 2018.

(30) Foreign Application Priority Data
Sep. 3, 2018 (CN) 201821436068.4

(51) Int. Cl. G02F 1/1343; G02F 1/1368; G02F 1/1362; G02F 1/1335

(52) U.S. Cl. CPC G02F 1/134309; G02F 1/1368; G02F 1/136286; G02F 2001/134345; G02F 2001/133531; G02F 2201/123; G02F 2201/122; G02F 1/133528

(57) ABSTRACT

The preset disclosure provides a display panel and a display device. The display panel includes a first polarizer, an array substrate, a color film substrate, and a second polarizer stacked one another in sequence, the horizontal interval-zone or the vertical interval-zone cooperates with the first light transmission axis of the first polarizer to form an angle θ, 0°<θ<90°.

### CROSS REFERENCE TO RELATED APPLICATIONS

The present application is a Continuation Application of PCT Application No. PCT/CN2018/111335 filed on Oct. 23, 2018, which claims the benefit of Chinese Patent Application No. 201821436068.4 filed on Sep. 3, 2018. All the above are hereby incorporated by reference.

### FIELD

The disclosure generally relates to the technical field of display, and more particularly relates to a display panel and a display device.

### BACKGROUND

The brightness of display panel depends on the product of the brightness of backlight source and the transmittance of display screen. Currently, the brightness of the display panel may be increased mostly by increasing the brightness of the backlight source. However, this makes a high overall cost, and the temperature increment of the backlight source may also induce other quality problems.

### SUMMARY

It is therefore one main object of the present disclosure to provide a display panel, aiming to improve the brightness of the display panel and reduce the cost.

In order to achieve the above object, the display panel provided by the present disclosure includes a first polarizer, an array substrate, a color film substrate, and a second polarizer stacked one another in sequence, a liquid crystal layer is defined between the array substrate and the color film substrate, a first light transmission axis of the first polarizer is perpendicular to a second light transmission axis of the second polarizer.

The array substrate defines a plurality of pixel units, each of the pixel units includes a pixel electrode, the central of the pixel electrode defines a horizontal interval-zone or a vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°.

Electively, θ is 45°.

Electively, the horizontal interval-zone has a width of 2 μm to 40 μm.

Electively, the vertical interval-zone has a width of 2 μm to 20 μm.

Electively, the array substrate further defines a plurality of data lines and a plurality of scan lines, the plurality of scan lines cross with the plurality of data lines to define a plurality of the pixel units, the pixel electrode of each of the pixel units electrically connects with corresponding data line and scan line.

Electively, each of the pixel units further includes a thin film transistor, a gate electrode of the thin film transistor electrically connects to the scan line, a source electrode of the thin film transistor electrically connects to the data line, a drain electrode of the thin film transistor electrically connects to the pixel electrode.

Electively, each of the pixel units further includes a common electrode defined on the pixel electrode, the horizontal interval-zone and the common electrode are in different layers and insulate with each other, or the vertical interval-zone and the common electrode are in different layers and insulate with each other.

Electively, the pixel electrode is an indium tin oxide electrode.

Electively, the array substrate and the color film substrate are both transparent substrate.

The present disclosure further provides a display device, which includes a display panel, the display panel includes a first polarizer, an array substrate, a color film substrate, and a second polarizer stacked one another in sequence, a liquid crystal layer is defined between the array substrate and the color film substrate, a first light transmission axis of the first polarizer is perpendicular to a second light transmission axis of the second polarizer;

the array substrate defines a plurality of pixel units, each of the pixel units includes a pixel electrode, the central of the pixel electrode defines a horizontal interval-zone or a vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°.

For the display panel of the present disclosure, the first light transmission axis of the first polarizer is set to be perpendicular to the second light transmission axis of the second polarizer, when the light moves to the array substrate through the first polarizer, as the central of the pixel electrode defines the horizontal interval-zone or the vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°, then when the light passes through the second polarizer, the light transmittance is increased, and the brightness of the display panel is further increased. Therefore, the brightness of the display panel is increased and the cost is decreased without increasing the brightness of the backlight source.

### BRIEF DESCRIPTION OF THE DRAWINGS

To better illustrate the technical solutions that are reflected in various embodiments according to this disclosure or that are found in the prior art, the accompanying drawings intended for the description of the embodiments herein or for the prior art will now be briefly described, it is evident that the accompanying drawings listed in the following description show merely some embodiments according to this disclosure, and that those having ordinary skill in the art will be able to obtain other drawings based on the arrangements shown in these drawings without making inventive efforts.

FIG. 1 is cross section diagram of the display panel of the present disclosure according to an exemplary embodiment;

FIG. 2 is a structure diagram of a part of the display panel of the present disclosure according to an exemplary embodiment;

FIG. 3 is similar to FIG. 2, but shown in another view;

FIG. 4 is a structure diagram of a part of the display panel of the present disclosure according to another exemplary embodiment;

FIG. 5 is similar to FIG. 4, but shown in another view;

FIG. 6 is a plane structure diagram of the array substrate of the present disclosure according to an exemplary embodiment.

### LABELS ILLUSTRATION FOR DRAWINGS

TABLE 1

| Label | Name | Label | Name |
|---|---|---|---|
| 100 | display panel | 212 | thin film transistor |
| 10 | first polarizer | 22 | data line |
| 11 | first light transmission axis | 23 | scan line |
| 20 | array substrate | 24 | first substrate |
| 21 | pixel unit | 30 | color film substrate |
| 211 | pixel electrode | 31 | second substrate |
| 2110 | sub-pixel region | 40 | second polarizer |
| 2111 | strip branch | 41 | second light transmission |
| | | | axis |
| 211a | horizontal interval-zone | 50 | liquid crystal layer |
| 211b | vertical interval-zone | | |

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, all of the directional instructions in the exemplary embodiments of the present disclosure (such as top, down, left, right, front, back . . . ) can only be used for explaining relative position relations, moving condition of the elements under a special form (referring to figures), and so on, if the special form changes, the directional instructions changes accordingly.

In the present disclosure, unless specified or limited otherwise, the terms “connected,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In addition, the descriptions, such as the “first”, the “second” in the present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

The present disclosure provides a display panel 100.

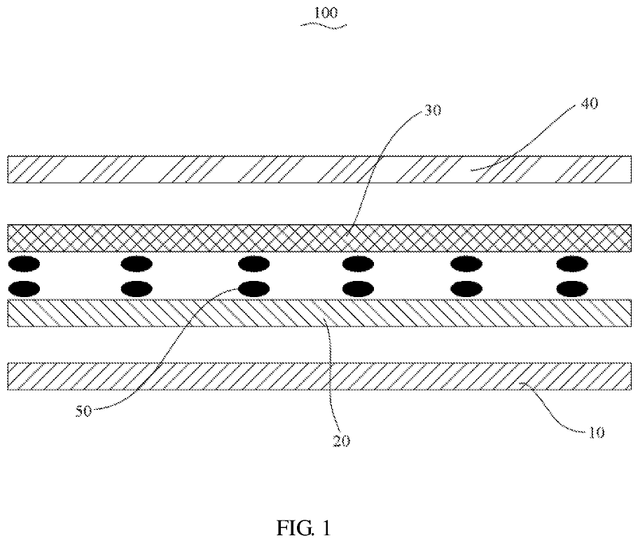

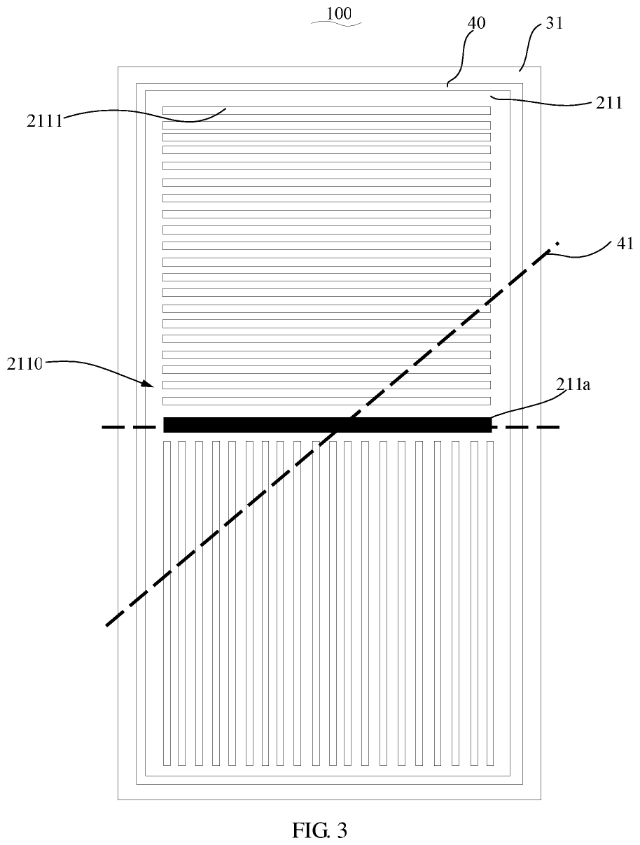

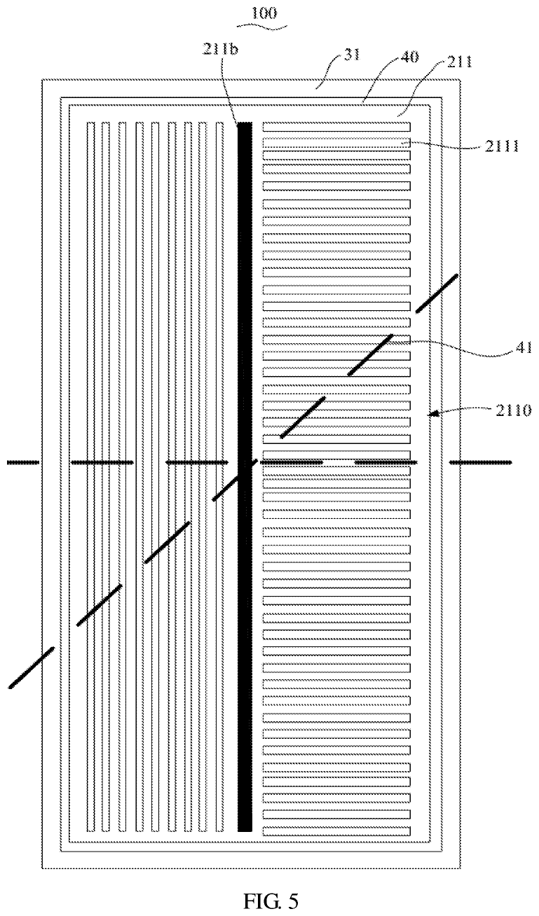

Referring to FIGS. 1-6, in the exemplary embodiment of the present disclosure, the display panel 100 includes: a first polarizer 10, an array substrate 20, a color film substrate 30, and a second polarizer 40 stacked one another in sequence, a liquid crystal layer 50 is defined between the array substrate 20 and the color film substrate 30, a first light transmission axis 11 of the first polarizer 10 is perpendicular to a second light transmission axis 41 of the second polarizer 41.

The array substrate 20 defines a plurality of pixel units 21, each of the pixel units 21 includes a pixel electrode 211, the central of the pixel electrode 211 defines a horizontal interval-zone 211a or a vertical interval-zone 211b, the horizontal interval-zone 211a or the vertical interval-zone 211b divides the pixel electrode 211 into two sub-pixel regions 2110, the two sub-pixel regions 2110 are both internally provided with a plurality of strip branches 2111 parallel to each other, and the strip branches 2111 in the two sub-pixel regions 2110 are perpendicular to each other, the strip branches 2111 in one of the sub-pixel regions 2110 are parallel to the horizontal interval-zone 211a or the vertical interval-zone 211b, the horizontal interval-zone 211a or the vertical interval-zone 211b cooperates with the first light transmission axis 11 of the first polarizer 10 to form an angle θ, 0°<θ<90°.

In detail, the array substrate 20 and the color film substrate 30 can both be a transparent substrate, for example, a glass substrate, a quartz substrate, etc. The array substrate 20 includes a first substrate 24, the color film substrate 30 includes a second substrate 31, the inner side of the first substrate 24 and the inner side of the second substrate 31 opposite to the inner side of the first substrate 24 respectively define a pixel electrode and a common electrode, and a liquid crystal layer 50 is defined between the first substrate 24 and the second substrate 31, an electric field is formed between the pixel electrode and the common electrode by applying a voltage between the pixel electrode and the common electrode, the rotating of the liquid crystal molecules in the liquid crystal layer 50 are controlled by the electric field, such the light of the backlight module is refracted to generate images.

The pixel electrode 211 of the array substrate 20 can be a translucent electrode or a reflecting electrode. When the pixel electrode 211 is the translucent electrode, the pixel electrode 211 may include a transparent conductive layer. The transparent conductive layer may include, such as, at least one selected from a group consisting of indium tin oxide (ITO), indium oxide zinc (IZO), zinc oxide (ZnO), indium oxide (In₂O₃), indium gallium oxide (IGO), and alumina zinc (AZO). Apart from the transparent conductive layer, the pixel electrode 211 may further include a translucence reflecting layer which can improve the luminous efficiency. The translucence reflecting layer can be a thin layer (for example, the translucence reflecting layer has a thickness of several nanometers to dozens of nanometers), and the translucence reflecting layer can include at least one selected from a group consisting of Ag, Mg, Al, Pt, Pd, Au, Ni, Nd, Ir, Cr, Li, Ca, and Yb. In the exemplary embodiment, preferably, the pixel electrode 211 is the indium tin oxide electrode.

The basic structure of the first polarizer 10 and the second polarizer 40 include: polyvinyl alcohol (PVA) located at the middle position, two triacetyl cellulose (TAC) layers, a polyisobutylene (PSA) film, a release film, and a protective film. The PVA layer plays a role of polarization, while as PVA is easy to hydrolyze, in order to protect the physical property of the polarizing film, two sides of the PVA should both be defined with the TAC film to protect the PVA, the TAC film has the advantages of high light transmittance, good water resistance, good mechanical strength, such the polarizer original plate is formed. During the processing of the normal TN type LCD polarizer, it needs to coat a certain mount of PSA on a side of the polarizer original plate, and to form the release film for protecting PSA, according to the different use requirements. While the other side of the polarizer original plate is defined with a composite protective film, a reflecting film, or a semi-permeable semi-reflective film according to the type of the product, thus the polarizer is formed. For the STN type LCD polarizer, according to customers' different requirements, the side having the PSA layer should be defined with a protective film and a retardation film for compensating phase difference according to a certain compensation angle, thus the STN type LCD polarizer is formed. The first polarizer 10 and the second polarizer 40 both have one polarization direction, when the first light transmission axis 11 of the first polarizer 10 is perpendicular to the second light transmission axis 41 of the second polarizer 40, the images can be displayed.

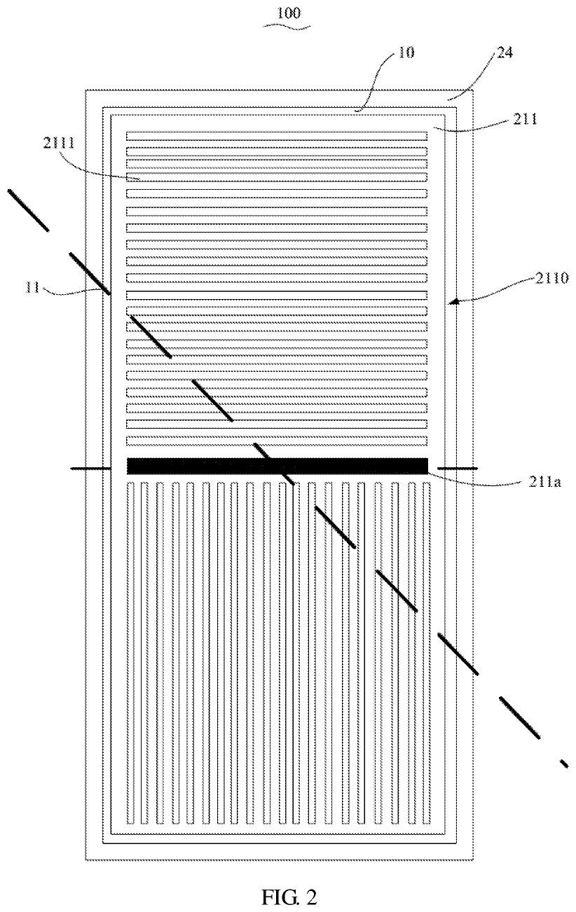

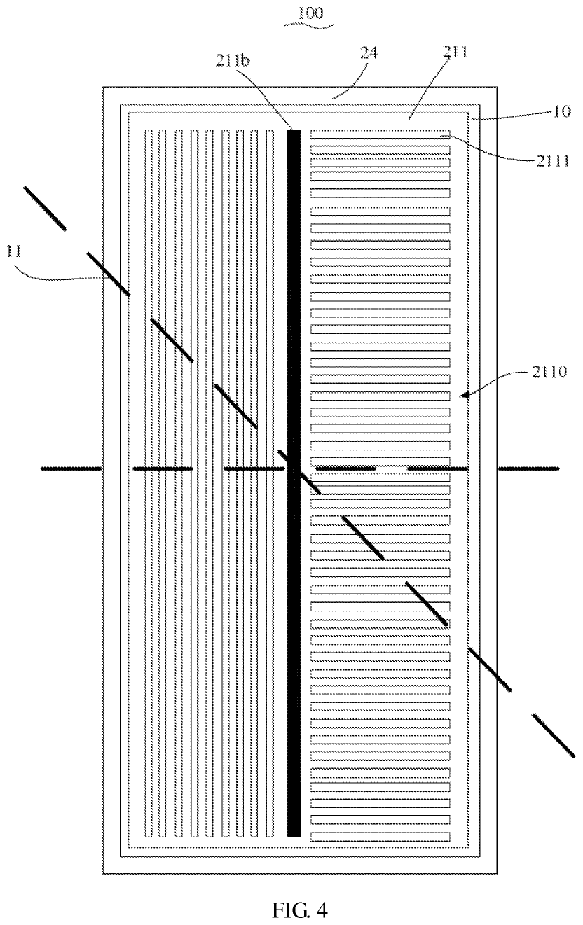

In order to broaden the view angle, the pixel electrode 211 is internally provided with strip branches 2111 with different orientations, each orientation area of the strip branch 2111 is defined as a domain. In the exemplary embodiment, the pixel electrode 211 includes four domains which have the same size and are arranged Symmetrically. The horizontal interval-zone 211a or the vertical interval-zone 211b divides the pixel electrode 211 into two sub-pixel regions 2110 which have the same size. One of the sub-pixel regions 2110 is formed by two adjacent domains which are connected with each other, the other sub-pixel region 2110 is formed by the other two adjacent domains which are connected with each other, each sub-pixel region 2110 is substantially rectangular shaped. The strip branches 2111 in two adjacent sub-pixel regions 2110 have different orientations, thus the liquid crystals respectively corresponding to the two sub-pixel regions 2110 have different rotation direction, the strip branches 2111 in each of the sub-pixel regions 2110 are parallel to each other, and the apertures of the strip branches 2111 have the same size, the liquid crystals in a border region of the sub-pixel regions 2110 would rotate disorderly, such the brightness would become abnormal, the dark state becomes shine. In order to avoid the phenomenon, the border region of the sub-pixel regions 2110 defines the horizontal interval-zone 211a or the vertical interval-zone 211b to avoid the liquid crystal at the border region from rotating disorderly. The horizontal interval-zone 211a or the vertical interval-zone 211b is a lightproof dark state when displays, in the exemplary embodiment, each pixel electrode 211 includes one horizontal interval-zone 211a or one vertical interval-zone 211b. Referring to FIGS. 2 and 4, which show the arrangement modes of the two kinds of the strip branches 2111, but the arrangements of the strip branches 2111 are not limited to the two arrangement modes.

The strip branches 2111 in the one sub-pixel regions 2110 are set to be perpendicular to the strip branches 2111 in the other one sub-pixel regions 2110 through the spatial perspective fusion method, the strip branches 2111 in one sub-pixel region 2110 are parallel to the horizontal interval-zone 211a or the vertical interval-zone 211b, the horizontal interval-zone 211a or the vertical interval-zone 211b cooperates with the first light transmission axis 11 of the first polarizer 10 to form an angle θ, 0°<θ<90°, one horizontal interval-zone 211a or one vertical interval-zone 211b is reserved to increase the aperture ratio of pixel.

For the display panel 100 of the present disclosure, the first light transmission axis 11 of the first polarizer 10 is set to be perpendicular to the second light transmission axis 41 of the second polarizer 40, when the light moves to the array substrate 20 through the first polarizer 10, as the central of the pixel electrode 211 defines the horizontal interval-zone 211a or the vertical interval-zone 211b, the horizontal interval-zone 211a or the vertical interval-zone 211b divides the pixel electrode 211 into two sub-pixel regions 2110, the two sub-pixel regions 2110 are both internally provided with a plurality of strip branches 2111 parallel to each other, and the strip branches 2111 in the two sub-pixel regions 2110 are perpendicular to each other, the strip branches 2111 in one of the sub-pixel regions 2110 are parallel to the horizontal interval-zone 211a or the vertical interval-zone 211b, the horizontal interval-zone 211a or the vertical interval-zone 211b cooperates with the first light transmission axis 11 of the first polarizer 10 to form an angle θ, 0°<θ<90°, then when the light passes through the second polarizer 40, the light transmittance is increased, and the brightness of the display panel 100 is further increased. Therefore, the brightness of the display panel 100 is increased and the cost is decreased without increasing the brightness of the backlight source.

Furthermore, in the exemplary embodiment, when θ is 45°, the light transmittance is at its maximum, and the implementation effect is best.

Furthermore, as each of the pixel electrodes 211 is internally provided with one horizontal interval-zone 211a or vertical interval-zone 211b, in order not to make the liquid crystal to rotate disorderly, and to improve the light transmittance, when the pixel electrode 211 is internally provided with one horizontal interval-zone 211a, the horizontal interval-zone 211a has a width of 2 μm to 40 μm, preferably, the width of the horizontal interval-zone 211a is 2 μm, 20 μm, or 40 μm.

In the exemplary embodiment, when the width of the horizontal interval-zone 211a is less than 2 μm, the liquid crystal would rotate disorderly, thus the brightness of the display panel 100 becomes unusual. When the width of the horizontal interval-zone 211a is more than 40 μm, the light transmittance reduces, which is not benefit for improving the brightness of the display panel 100. Such, the width of the horizontal interval-zone 211a should be defined in a range of 2 μm to 40 μm.

Similarly, the vertical interval-zone 211b has a width of 2 μm to 20 μm. Preferably, the width of the vertical interval-zone 211b can be 2 μm, 10 μm or 20 μm.

In the exemplary embodiment, when the width of the vertical interval-zone 211b is less than 2 μm, the liquid crystal would rotate disorderly, thus the brightness of the display panel 100 becomes unusual. When the width of the vertical interval-zone 211b is more than 20 μm, the light transmittance reduces, which is not benefit for improving the brightness of the display panel 100. Such, the width of the vertical interval-zone 211b should be defined in a range of 2 μm to 20 μm.

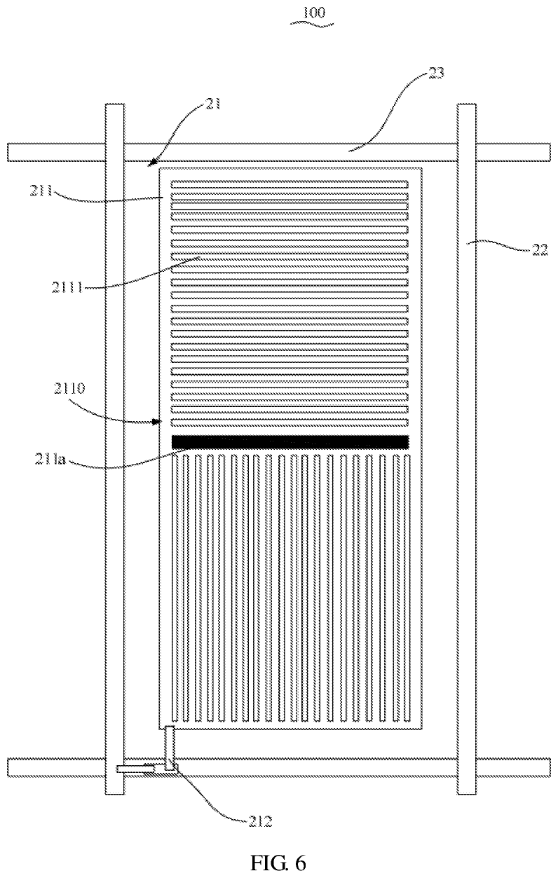

Referring to FIG. 6, the array substrate 20 further defines a plurality of data lines 22 and a plurality of scan lines 23, the plurality of scan lines 22 cross with the plurality of data lines 23 to define a plurality of the pixel units 21, the pixel electrode 211 of each of the pixel units 21 electrically connects with corresponding data line 23 and scan line 22.

In the exemplary embodiment, the scan lines 23 and the data lines 22 are all made of conducting material, such as, aluminium alloy, chromium metal, etc. The array substrate 20 includes a plurality of pixel units 21 arranged in matrix, the scan lines 23 insulate and cross with the data lines 22 to define a plurality of pixel units 21, the scan lines 23 are perpendicular to the data lines 22, and the plurality of scan lines 23 are parallel to each other and spaced from each other. The plurality of data lines 22 are parallel to each other and spaced from each other, two adjacent data lines 22 and two adjacent scan lines 23 cooperatively form a pixel unit 21. The pixel electrode 211 of each of the pixel units 21 electrically connects to the corresponding data line 23 and the scan line 22 to realize the correct orientation of liquid crystal.

Referring to FIG. 6, each of the pixel units 21 further includes a thin film transistor 212, a gate electrode of the thin film transistor 212 electrically connects to the scan line 22, a source electrode of the thin film transistor 212 electrically connects to the data line 23, a drain electrode of the thin film transistor 212 electrically connects to the pixel electrode 211.

In the exemplary embodiment, the gate electrode of the thin film transistor 212 electrically connects to the scan line 22, the gate electrode and the scan line 22 are normally made of the same material and manufactured simultaneously. The source electrode of the thin film transistor 212 electrically connects to the data line 23, the source electrode electrically connects to the corresponding data line 23. The drain electrode of the thin film transistor 212 electrically connects to the pixel electrode 211. Normally the source electrode and the drain electrode and the data line 23 are made of the same material and manufactured simultaneously. The thin film transistor 212 further includes an active layer (not shown), the active layer may include a semiconductor layer and a doped semiconductor layer, the active layer is located below the source electrode and the drain electrode, and located upon the gate electrode. All the doped semiconductor layer and a part of the semiconductor layer, between the source electrode and the drain electrode, are etched to form a TFT channel. When the gate electrode is provided with high level, the source electrode is conducted with the drain electrode through the active layer, and the image signal voltage in the data line 23 is inputted to pixel electrode 211. In order to maintain that the conducting structures insulate with each other, the insulation layer covered on the scan line 22 and the gate electrode is gate electrode insulation layer, the insulation layer covered on the data line 23, the active layer, the source electrode, and the drain electrode is passivation layer. The pixel electrode 211 is formed on the passivation layer, the pixel electrode 211 connects with the drain electrode through a through hole in the passivation layer.

Furthermore, each of the pixel units 21 further includes a common electrode defined on the pixel electrode 211, the horizontal interval-zone 211a and the common electrode 211 are in different layers and insulate with each other, or the vertical interval-zone 211b and the common electrode 211 are in different layers and insulate with each other.

In the exemplary embodiment, the voltage of common electrode (not shown) on the array substrate 20 equates with the voltage of the common electrode on the color film substrate 30, such there are two functions: the common electrode and the pixel electrode 211 cooperatively form a storage capacitor; the electric field is shielded to prevent the edge from light leaking. The horizontal interval-zone 211a and the common electrode 211 are in different layers and insulate with each other, or the vertical interval-zone 211b and the common electrode 211 are in different layers and insulate with each other. It is to be understood that, the horizontal interval-zone 211a or the vertical interval-zone 211b stacked with the common electrode, or an insulation layer is sandwiched between the horizontal interval-zone 211a or the vertical interval-zone 211b, and the common electrode, arranging the horizontal interval-zone 211a (or the vertical interval-zone 211b) and the common electrode in different layers can realize that the wiring can pass through different metal layers, to avoid the short signal connection.

The manufacture procedures for the pixel electrode 211 on the array substrate 20 of the present disclosure main include: coating, photoresist coating, exposure, development, etching, dephotoresist. The aim of increasing the aperture ratio is achieved by only providing one horizontal interval-zone 211a or one vertical interval-zone 211b for each pixel electrode 211 without adding additional photomask and manufacture procedures.

The present disclosure also provides a display device, the display device includes a display panel 100. The detail structure of the display panel 100 can be referred to the foregoing exemplary embodiments. As the display device adopts all the technical proposals of the above exemplary embodiments, the display device at least has all of the beneficial effects of the technical proposals of the above exemplary embodiments, no need to repeat again.

The foregoing description merely depicts some illustrative embodiments of the present application and therefore is not intended to limit the scope of the application. An equivalent structural or flow changes made by using the content of the specification and drawings of the present application, or any direct or indirect applications of the disclosure on any other related fields shall all fall in the scope of the application.

What is claimed is:

1. A display panel, wherein, the display panel comprises a first polarizer, an array substrate, a color film substrate, and a second polarizer stacked one another in sequence, a liquid crystal layer is defined between the array substrate and the color film substrate, a first light transmission axis of the first polarizer is perpendicular to a second light transmission axis of the second polarizer;
the array substrate defines a plurality of pixel units, each of the pixel units comprises a pixel electrode, the central of the pixel electrode defines a horizontal interval-zone or a vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°.

2. The display panel according to claim 1, wherein, θ is 45°.

3. The display panel according to claim 1, wherein, the horizontal interval-zone has a width of 2 μm to 40 μm.

4. The display panel according to claim 1, wherein, the vertical interval-zone has a width of 2 μm to 20 μm.

5. The display panel according to claim 1, wherein, the array substrate further defines a plurality of data lines and a plurality of scan lines, the plurality of scan lines cross with the plurality of data lines to define a plurality of the pixel units, the pixel electrode of each of the pixel units electrically connects with corresponding data line and scan line.

6. The display panel according to claim 5, wherein, each of the pixel units further comprises a thin film transistor, a gate electrode of the thin film transistor electrically connects to the scan line, a source electrode of the thin film transistor electrically connects to the data line, a drain electrode of the thin film transistor electrically connects to the pixel electrode.

7. The display panel according to claim 6, wherein, each of the pixel units further comprises a common electrode defined on the pixel electrode, the horizontal interval-zone and the common electrode are in different layers and insulate with each other, or the vertical interval-zone and the common electrode are in different layers and insulate with each other.

8. The display panel according to claim 1, wherein, the pixel electrode is an indium tin oxide electrode.

9. The display panel according to claim 1, wherein, the array substrate and the color film substrate are both transparent substrate.

10. A display device, wherein, the display device comprises a display panel, the display panel comprises a first polarizer, an array substrate, a color film substrate, and a second polarizer stacked one another in sequence, a liquid crystal layer is defined between the array substrate and the color film substrate, a first light transmission axis of the first polarizer is perpendicular to a second light transmission axis of the second polarizer;
the array substrate defines a plurality of pixel units, each of the pixel units comprises a pixel electrode, the central of the pixel electrode defines a horizontal interval-zone or a vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°.

11. The display device according to claim 10, wherein, θ is 45°.

12. The display device according to claim 10, wherein, the horizontal interval-zone has a width of 2 μm to 40 μm.

13. The display device according to claim 10, wherein, the vertical interval-zone has a width of 2 μm to 20 μm.

14. The display device according to claim 10, wherein, the array substrate further defines a plurality of data lines and a plurality of scan lines, the plurality of scan lines cross with the plurality of data lines to define a plurality of the pixel units, the pixel electrode of each of the pixel units electrically connects with corresponding data line and scan line.

15. The display device according to claim 14, wherein, each of the pixel units further comprises a thin film transistor, a gate electrode of the thin film transistor electrically connects to the scan line, a source electrode of the thin film transistor electrically connects to the data line, a drain electrode of the thin film transistor electrically connects to the pixel electrode.

16. The display device according to claim 15, wherein, each of the pixel units further comprises a common electrode defined on the pixel electrode, the horizontal interval-zone and the common electrode are in different layers and insulate with each other, or the vertical interval-zone and the common electrode are in different layers and insulate with each other.

17. The display device according to claim 10, wherein, the pixel electrode is an indium tin oxide electrode.

18. The display device according to claim 10, wherein, the array substrate and the color film substrate are both transparent substrate.

19. A display panel, wherein, the display panel comprises a first polarizer, an array substrate, a color film substrate, and a second polarizer stacked one another in sequence, a liquid crystal layer is defined between the array substrate and the color film substrate, a first light transmission axis of the first polarizer is perpendicular to a second light transmission axis of the second polarizer;
the array substrate defines a plurality of pixel units, each of the pixel units comprises a pixel electrode, the central of the pixel electrode defines a horizontal interval-zone or a vertical interval-zone, the horizontal interval-zone or the vertical interval-zone divides the pixel electrode into two sub-pixel regions, the two sub-pixel regions are both internally provided with a plurality of strip branches parallel to each other, and the strip branches in the two sub-pixel regions are perpendicular to each other, the strip branches in one of the sub-pixel regions are parallel to the horizontal interval-zone or the vertical interval-zone, the horizontal interval-zone or the vertical interval-zone cooperates with the first light transmission axis of the first polarizer to form an angle θ, 0°<θ<90°, the horizontal interval-zone has a width of 20 μm, the vertical interval-zone has a width of 10 μm.
